(19) United States
(12) Patent Application Publication
(10) Pub. No.: US 2023/0335950 A1
(43) Pub. Date: Oct. 19, 2023

(54) ANTI-ENTRY DEVICE FOR SINGLE PAIR ETHERNET FEMALE CONNECTOR OR COUPLER

(71) Applicant: CommScope Technologies LLC, Hickory, NC (US)

(72) Inventors: Zhihui LIU, Jiangsu (CN); Wenyong WU, Jiangsu (CN)

(21) Appl. No.: 18/300,777

(22) Filed: Apr. 14, 2023

(30) Foreign Application Priority Data
Apr. 15, 2022 (CN) 202220872401.6

(51) Int. Cl. H01R 13/639; H01R 13/629; H01R 13/502

(52) U.S. Cl. CPC H01R 13/6397; H01R 13/62927; H01R 13/502; H01R 2201/04; H01R 2103/00

(57) ABSTRACT

The present disclosure relates to an anti-entry device for a single pair Ethernet female connector or coupler, which is configured to prevent accidental entry or unauthorized entry from outside into a hollow interior of the female connector or coupler, and includes: a protective cover, which includes a base plate, a holding portion, and a locking portion. An unlocking rod can be provided and capable of passing through a through-hole of the protective cover to press the locking portion downward so as to unlock the protective cover from the female connector or coupler.

### RELATED APPLICATION

This application claims priority to Chinese Patent Application Serial Number 202220872401.6 filed on Apr. 15, 2022, the entirety of which is incorporated by reference herein.

### TECHNICAL FIELD

The present disclosure generally relates to the field of single pair Ethernet connectors. More specifically, the present disclosure relates to an anti-entry device for a single pair Ethernet female connector or coupler.

### BACKGROUND ART

With the rapid development of industrial Internet of Things (IOT), single pair Ethernet (SPE) is attracting more and more attention. Single pair Ethernet is an advanced and simple form of Ethernet connection, which can transmit data and power using only a pair of copper wires and provide reliable and efficient communication. Therefore, single pair Ethernet has such merits as simple wiring, low cost, light weight, reliability, high efficiency and ease of installation.

In some cases, it is necessary to use a single pair Ethernet connector assembly to connect single pair Ethernet cables to transmit data and power, or to extend the length of single pair Ethernet cables. A single pair Ethernet connector assembly includes a male connector and a female connector or a coupler fitting with each other. The male connector can be inserted and locked in the female connector or the coupler, and can be unlocked from the female connector or the coupler by pressing an unlocking piece. When the male connector is not inserted into the female connector or the coupler, a hollow interior of the female connector or the coupler is open to the outside, and this can easily lead to accidental entry or unauthorized entry of external objects into the hollow interior.

### SUMMARY

The present disclosure provides an anti-entry device for a single pair Ethernet female connector or coupler that can overcome at least one of the aforementioned defects of products of the state of the art.

One aspect of the present disclosure relates to an anti-entry device for a single pair Ethernet female connector or coupler, wherein the anti-entry device is configured to prevent accidental entry or unauthorized entry from outside into a hollow interior of the female connector or coupler, and includes: a protective cover, which includes a base plate, a holding portion, and a locking portion, the base plate being configured to cover a proximal end opening of the female connector or coupler after the protective cover is installed, and including a through-hole, the holding portion being configured to extend distally from the base plate and to hold the base plate on the proximal end opening of the female connector or coupler, the locking portion being configured to extend from the base plate or the holding portion and removably lock the base plate to a guide block at the proximal end opening of the female connector; an unlocking rod, which is elongated and capable of passing through the through-hole of the protective cover to press the locking portion downward so as to unlock the protective cover from the female connector or coupler; wherein the holding portion includes a top wall, a bottom wall, and two side walls connecting the top wall and the bottom wall, wherein the top wall is flat and is under and abuts against a guide bar of the female connector, the bottom wall is flat and is above and abuts against the bottom wall in the proximal end opening of the female connector, and the two side walls are curved following the contours of the side walls in the proximal end opening of the female connector.

In some embodiments, an outer contour shape of the base plate is designed to follow an outer contour shape of the female connector or coupler at the proximal end opening, and the base plate includes a flat lower side part and an upper side part curved distally.

In some embodiments, the lower side part is configured to abut against lower parts of two opposite side walls and a bottom wall of the female connector, and the upper side part is configured to abut against upper parts of the two opposite side walls and a top wall of the female connector.

In some embodiments, the through-hole is set to be all on the upper side part, or set to be partly on the upper side part and partly on the lower side part.

In some embodiments, the through-hole is set to be on the upper side part, and a lower edge of the through-hole is at a position where the lower side part and the upper side part connect.

In some embodiments, the holding portion is in a shape of a hollow frame or a shape of a solid block.

In some embodiments, the holding portion is configured to extend distally from the lower side part of the base plate, and its vertical cross-sectional shape matches the lower side part in the proximal end opening of the female connector.

In some embodiments, the locking portion includes an elastic plate and a hook-shaped portion, wherein the elastic plate extends distally from the lower edge of the through-hole of the protective cover, the hook-shaped portion is provided at a distal end of the elastic plate and protrudes upward from an upper surface of the elastic plate.

In some embodiments, the elastic plate has a width designed to be equal to or greater than that of the through-hole.

In some embodiments, the hook-shaped portion includes a vertical proximal surface and an inclined distal surface, wherein the vertical proximal surface is configured to abut against a distal end surface of the guide block, and the inclined distal surface is configured to guide the hook-shaped portion over the guide block.

In some embodiments, after the protective cover is installed, the guide block of the female connector is sandwiched between the base plate of the protective cover and the hook-shaped portion of the locking portion on both proximal and distal sides, and faces the elastic plate of the locking portion on the lower side surface.

In some embodiments, the locking portion includes a guide slope configured to guide the unlocking rod over the hook-shaped portion, wherein the guide slope is provided to abut the proximal side of the hook-shaped portion.

In some embodiments, the guide slope has a width smaller than that of a gap between the two guide blocks of the female connector, so that after the protective cover is installed, the guide slope is in the gap.

In some embodiments, the unlocking rod includes a handle and a rod extending distally from the handle, and the handle has a width far greater than that of the rod.

In some embodiments, the handle has rough texture to make it easy for a user to hold it without slipping.

In some embodiments, along the longitudinal direction, the rod includes an insertable section, which can be inserted into the protective cover, and an exposed section, which cannot be inserted into the protective cover, wherein the outer contour dimension of the insertable section is configured to be smaller than the dimension of the through-hole, and the outer contour dimension of the exposed section is configured to be greater than the dimension of the through-hole.

In some embodiments, a stopper is provided on the rod between the insertable section and the exposed section, and the stopper is configured to prevent the rod from being excessively inserted into the protective cover.

In some embodiments, the distal end of the insertable section is provided with an inclined surface that can slide through the guide slope of the protective cover to guide the insertable section over the hook-shaped portion, and the insertable section is provided with a recess at the proximal side of the inclined surface, the recess being configured to accommodate the hook-shaped portion and the guide slope on the curved elastic plate of the protective cover after the inclined surface goes over the guide slope of the protective cover.

In some embodiments, the through-hole of the protective cover includes two side-by-side through-holes, the locking portion includes two elastic plates and two hook-shaped portions, each elastic plate extends distally from an inner edge of a corresponding through-hole of the base plate, and each hook-shaped portion is provided at the distal end of each elastic plate and protrudes outward from an outer surface of the elastic plate.

In some embodiments, the elastic plate has a height designed to be equal to or greater than that of the through-hole.

In some embodiments, each hook-shaped portion includes a vertical proximal surface and an inclined distal surface, wherein the vertical proximal surface is configured to stably abut against the distal end surface of the guide block, and the inclined distal surface is configured to guide the hook-shaped portion smoothly over the guide block from an inner side.

In some embodiments, after the protective cover is installed, the guide block of the female connector is sandwiched between the base plate of the protective cover and the hook-shaped portion of the locking portion on both proximal and distal sides, and faces the elastic plate of the locking portion on the inner surface.

In some embodiments, the locking portion further includes a guide slope configured to guide the unlocking rod over the hook-shaped portion, and the guide slope is provided to abut the proximal side of the hook-shaped portion.

In some embodiments, the unlocking rod includes a handle and a rod extending distally from the handle, and the handle has a width far greater than that of the rod.

In some embodiments, the handle has rough texture to make it easy for a user to hold it without slipping.

In some embodiments, along the longitudinal direction, the rod includes an insertable section, which can be inserted into the protective cover, and an exposed section, which cannot be inserted into the protective cover, wherein the insertable section includes two protruding portions protruding distally from the exposed section, and the two protruding portions can be respectively inserted into the two through-holes of the protective cover.

In some embodiments, the distal end of the insertable section is provided with an inclined surface that can slide through the guide slope of the protective cover to guide the insertable section over the hook-shaped portion, and the insertable section is provided with a recess at the proximal side of the inclined surface, the recess being configured to accommodate the hook-shaped portion and the guide slope on the curved elastic plate of the protective cover after the inclined surface goes over the guide slope of the protective cover.

In some embodiments, the locking portion includes an elastic plate, a distal end of the elastic plate is fixed to the top wall of the holding portion and protrudes obliquely to the proximal side.

In some embodiments, a proximal end of the elastic plate is designed to be widened.

In some embodiments, after the protective cover is installed, the guide block of the female connector is sandwiched between the base plate of the protective cover and the proximal end of the elastic plate of the locking portion on both proximal and distal sides, and faces the top wall of the holding portion on the lower side surface.

In some embodiments, the locking portion further includes a guide slope configured to guide the unlocking rod over the hook-shaped portion, the guide slope being provided on the proximal end of the elastic plate.

In some embodiments, the unlocking rod includes a handle and a rod extending distally from the handle, and the handle has a width far greater than that of the rod.

In some embodiments, the handle has rough texture to make it easy for a user to hold it without slipping.

In some embodiments, along the longitudinal direction, the rod includes an insertable section, which can be inserted into a protective cover, and an exposed section, which cannot be inserted into the protective cover, wherein the outer contour dimension of the insertable section is configured to be smaller than the dimension of the through-hole, and the outer contour dimension of the exposed section is configured to be greater than the dimension of the through-hole.

In some embodiments, a stopper is provided on the rod between the insertable section and the exposed section, and the stopper is configured to prevent the rod from being excessively inserted into the protective cover.

In some embodiments, the distal end of the insertable section is provided with an inclined surface that can slide through the guide slope of the protective cover to guide the insertable section over the hook-shaped portion, and the insertable section is provided with a recess at the proximal side of the inclined surface, the recess being configured to accommodate the hook-shaped portion and the guide slope on the curved elastic plate of the protective cover after the inclined surface goes over the guide slope of the protective cover.

An anti-entry device for a connector can also include a protective cover, which includes a base plate and a deflectable locking portion, the base plate being configured to cover a proximal end opening of the connector and including a through-hole, the deflectable locking portion including a latching portion for engaging with a interior surface within the connector to lock the base plate to the connector; and can include an unlocking rod including a member insertable through the through-hole to deflect the locking portion to disengage the latching portion from the connector interior surface so as to unlock the protective cover from the connector, and such that the member engages with the latching portion such that the protective cover can be removed from the proximal end opening with the unlocking rod.

In some embodiments, the member is a single member.

In some embodiments, the locking portion includes a guide slope configured to guide the unlocking rod member over the latch portion, wherein the guide slope abuts a proximal side of the latch portion.

Other features and advantages of the subject technology of the present disclosure will be explained in the description below, and in part will be apparent from the description, or may be learned by practice of the subject technology of the present disclosure. The advantages of the subject technology of the present disclosure will be realized and attained by the structure particularly pointed out in the written Specification and Claims hereof as well as the attached drawings.

It should be understood that both the foregoing general description and the following detailed description are exemplary and explanatory and are intended to provide further explanation of the subject technology of the present disclosure as claimed.

### BRIEF DESCRIPTION OF THE ATTACHED DRAWINGS

A plurality of aspects of the present disclosure will be better understood after reading the following specific embodiments with reference to the attached drawings. Among the attached drawings:

FIGS. 1A and 1B show perspective views of a single pair Ethernet connector assembly in a separated state and a fitted state.

FIG. 2 shows a perspective view of a male connector in FIG. 1.

FIGS. 3A 3B respectively show an exploded perspective view and an exploded cross-sectional view of a female connector in FIG. 1.

FIGS. 4A to 4C respectively show a perspective view and cutaway views of an assembled state of the female connector in FIG. 1.

FIG. 5 shows a perspective view of a single pair Ethernet connector assembly on which an anti-entry device according to a first embodiment of the present disclosure is mounted.

FIGS. 6A to 6C respectively show perspective views of different angles and top view of a protective cover of the anti-entry device in FIG. 5.

FIGS. 7A to 7B respectively show perspective views of different angles of an unlocking rod of the anti-entry device in FIG. 5.

FIGS. 8A to 8B respectively show a perspective view and a cross-sectional view of the anti-entry device in FIG. 5 installed in the female connector in FIG. 1.

FIGS. 9A to 11 respectively show operating steps of the anti-entry device in FIG. 5.

FIGS. 12A to 12C respectively show perspective views of different angles and top view of a protective cover of an anti-entry device according to a second embodiment of the present disclosure.

FIG. 13 shows a perspective view of an unlocking rod of the anti-entry device according to the second embodiment of the present disclosure.

FIGS. 14A and 14B show perspective views of the anti-entry device according to the second embodiment of the present disclosure when it is connected to the female connector and when it is to be removed from the female connector, respectively.

FIGS. 15A to 15C respectively show perspective views of different angles and top view of a protective cover of an anti-entry device according to a third embodiment of the present disclosure.

FIGS. 16A to 16B respectively show perspective views of different angles of an unlocking rod of the anti-entry device according to the third embodiment of the present disclosure.

FIGS. 17A and 17B show perspective views of the anti-entry device according to the third embodiment of the present disclosure when it is connected to the female connector and when it is to be removed from the female connector, respectively.

FIGS. 18A to 18B show perspective views of another example of the single pair Ethernet connector assembly in a separated state and a fitted state.

### DETAILED DESCRIPTION

The present disclosure will be described below with reference to the attached drawings, wherein the attached drawings illustrate certain embodiments of the present disclosure. However, it should be understood that the present disclosure may be presented in many different ways and is not limited to the embodiments described below; in fact, the embodiments described below are intended to make the disclosure of the present disclosure more complete and to fully explain the protection scope of the present disclosure to those of ordinary skill in the art. It should also be understood that the embodiments disclosed in the present disclosure may be combined in various ways so as to provide more additional embodiments.

It should be understood that in all the attached drawings, the same symbols denote the same elements. In the attached drawings, the dimensions of certain features can be changed for clarity.

It should be understood that the words in the Specification are only used to describe specific embodiments and are not intended to limit the present disclosure. Unless otherwise defined, all terms (including technical terms and scientific terms) used in the Specification have the meanings commonly understood by those of ordinary skill in the art. For brevity and/or clarity, well-known functions or structures may not be further described in detail.

The singular forms “a”, “an”, “the” and “this” used in the Specification all include plural forms unless clearly indicated. The words “comprise”, “contain” and “have” used in the Specification indicate the presence of the claimed features, but do not exclude the presence of one or more other features. The word “and/or” used in the Specification includes any or all combinations of one or a plurality of the related listed items. The words “between X and Y” and “between approximate X and Y” used in the Specification shall be interpreted as including X and Y. As used herein, the wording “between approximate X and Y” means “between approximate X and approximate Y”, and as used herein, the wording “from approximate X to Y” means “from approximate X to approximate Y”.

In the Specification, when it is described that an element is “on” another element, “attached” to another element, “connected” to another element, “coupled” to another element, or “in contact with” another element, etc., the element may be directly on another element, attached to another element, connected to another element, coupled to another element, or in contact with another element, or an intermediate element may be present. In contrast, if an element is described “directly” “on” another element, “directly attached” to another element, “directly connected” to another element, “directly coupled” to another element or “directly in contact with” another element, there will be no intermediate elements. In the specification, a feature that is arranged “adjacent” to another feature, may denote that a feature has a part that overlaps an adjacent feature or a part located above or below the adjacent feature.

In the Specification, words expressing spatial relations such as “upper”, “lower”, “left”, “right”, “front”, “distal”, “top”, and “bottom” may describe the relation between one feature and another feature in the attached drawings. It should be understood that, in addition to the locations shown in the attached drawings, the words expressing spatial relations further include different locations of a device in use or operation. For example, when a device in the attached drawings rotates reversely, the features originally described as being “below” other features now can be described as being “above” the other features”. The device may also be oriented by other means (rotated by 90 degrees or at other locations), and at this time, a relative spatial relation will be explained accordingly.

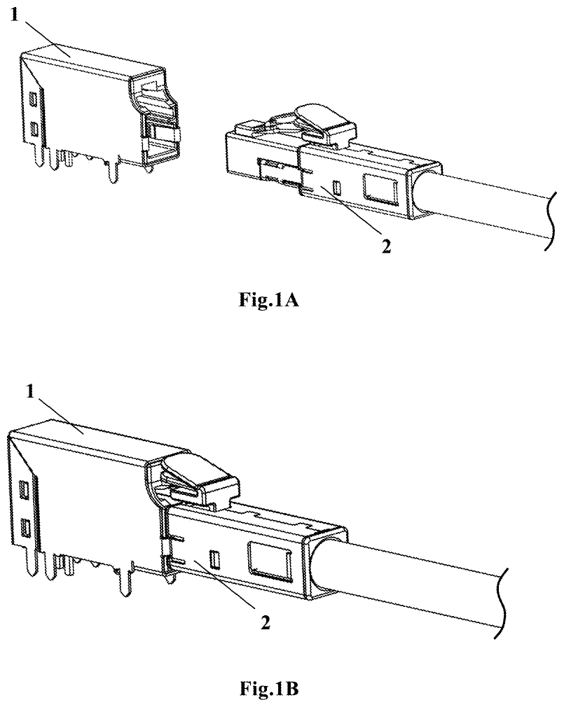

FIG. 1A and FIG. 1B show perspective views of a single pair Ethernet connector assembly in a separated state and a fitted state respectively, each shown connector having a single pair of electrical contacts. As shown in the figures, the connector assembly includes a female connector 1 and a male connector 2 fitted together, and the male connector 2 is removably inserted into the female connector 1 for fitting and locking. The single pair Ethernet connector assembly can be used together with various active devices or passive devices, including but not limited to patch panels, wall sockets, Ethernet switches, routers, servers, and Ethernet power supply equipment, etc. The female connector 1 may be located on a cabinet, a rack, or other infrastructure, and the male connector 2 is connected to a single pair Ethernet cable. An example connector having features usable with those disclosed herein is shown and described in U.S. Pat. No. 11,362,463, entitled “Connectors and contacts for a single twisted pair of conductors”, the entirety of which is incorporated by reference herein. In some examples the connector can be compliant with the IEC (International Electrotechnical Commission) standard for an LC connector, identified as IEC 61754-20, the noted IEC standard is hereby incorporated by reference.

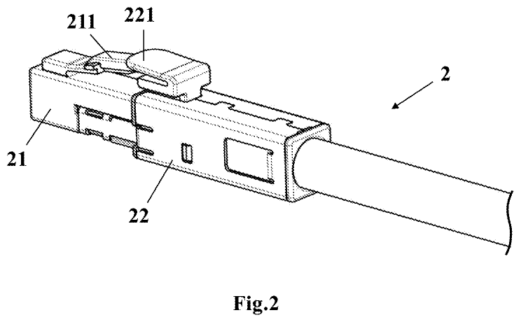

FIG. 2 shows a perspective view of the male connector 2. As shown in the figure, the male connector 2 includes a terminal carrier (not shown) inside, and a housing 21 and a shield cover 22 outside. The terminal carrier is configured to support a terminal (not shown) of the male connector 2 and to hold the terminal in place. The housing 21 is fixed to the terminal carrier of the male connector 2. An elastic locking piece 211 is provided on a top surface of the housing 21 to removably lock the male connector 2 to the female connector 2. The elastic locking piece 211 is connected to the top surface of the housing 21 in a flexible hinge manner, and protrudes from the top surface obliquely to a proximal side. A shield cover 22 encloses the entire terminal carrier and a proximal part of the housing 21. The shield cover 22 is made of metal to reduce the interference of external crosstalk from adjacent connectors. An elastic unlocking piece 221 is provided on a top surface of the shield cover 22 to be used to press a free end of the elastic locking piece 211 to remove the lock between the male connector 2 and the female connector 1 by the elastic locking piece 211 so that the male connector 2 can be removed from the female connector 1.

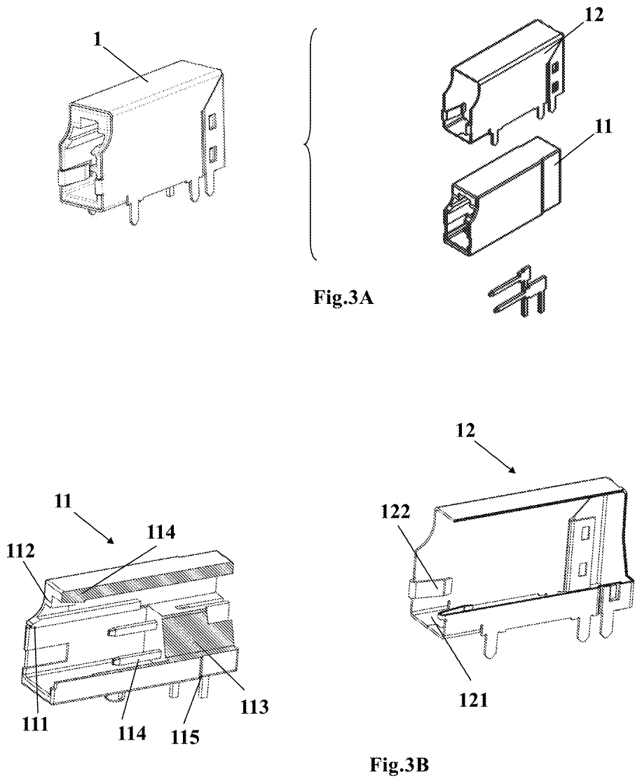

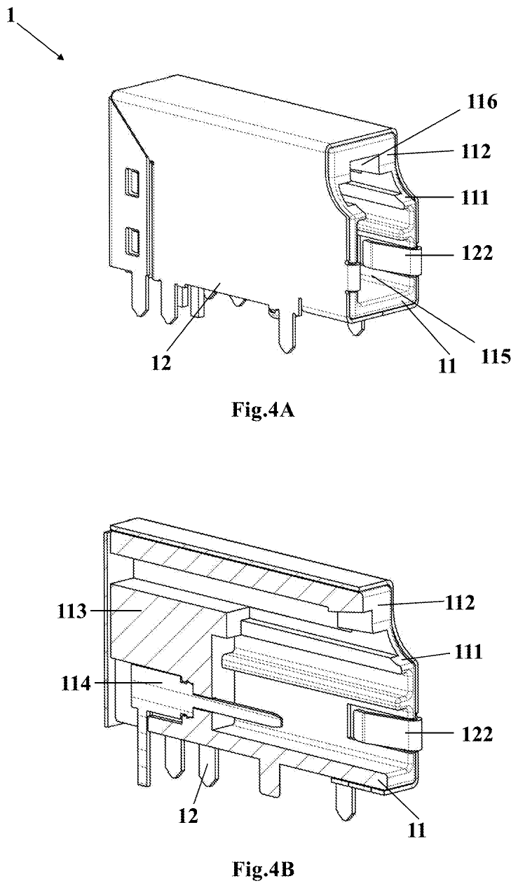

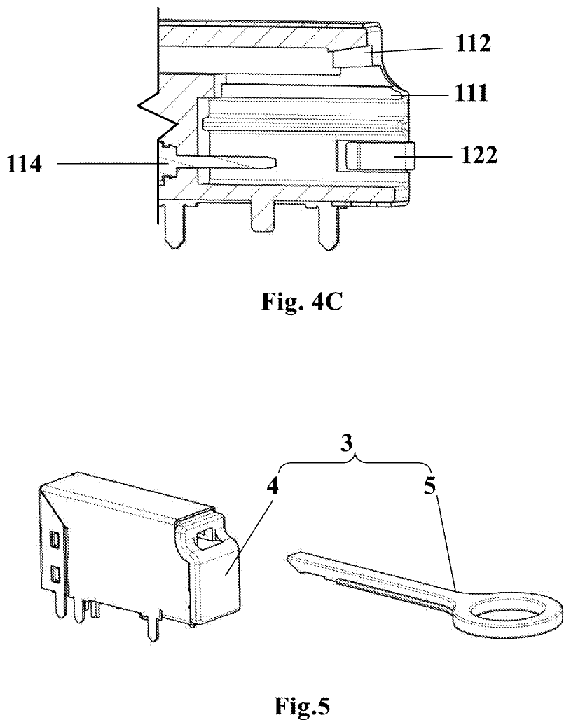

FIG. 3A and FIG. 3B show an exploded perspective view and an exploded cross-sectional view of the female connector 1, and FIGS. 4A-4C show a perspective view and cutaway views of an assembled state of the female connector 1. As shown in the figures, the proximal end of the female connector 1 is open and the distal end is closed. The female connector 1 includes a housing 11 and a shield cover 12. The housing 11 has a generally hollow rectangular parallelepiped shape, and the proximal and distal ends are open. At the distal side part of the hollow interior of the housing 11, a terminal carrier 113 is provided to support a terminal 114 of the female connector 1 and hold the terminal 114 in place. Guide bars 111 are provided at the proximal side part of the inner surfaces of two opposite side walls of the housing 11. The guide bars 111 protrude inward toward the interior surfaces of the side walls and extend longitudinally to guide the housing 21 of the male connector 2 to be inserted into the female connector 1. A proximal end opening 115 of the housing 11 has an outer contour curved distally at the upper parts of the two opposite side walls, and has a vertical outer contour at the lower parts of the two opposite side walls. The proximal end opening 115 of the housing 11 is provided with two opposite guide blocks 112 at the top wall. The two guide blocks 112 protrude downward from the inner surface of the top wall and are spaced apart from each other by a gap 116. The gap 116 is configured to guide the elastic locking piece 211 of the male connector 2 to be inserted into the hollow interior of the female connector 1. The top wall of the housing 11 is provided with a locking protrusion 114 at the distal side of the gap 116. The locking protrusion 114 protrudes downward from the interior surface of the top wall and extends horizontally. The locking protrusion 114 is fitted with the elastic locking piece 211 of the male connector 1 so that the male connector 2 can be removably locked in the female connector 1.

The shield cover 12 encloses the housing 11. The shield cover 12 is made of metal to reduce the interference of external crosstalk from adjacent connectors. The shield cover 12 has a generally hollow rectangular parallelepiped shape, and the proximal end is open while the distal end is closed. The outer contour shape of the shield cover 12 at a distal end opening 121 follows the outer contour shape of the housing 11 at the distal end opening 115. The shield cover 12 closes the open distal end of the housing 11. Flat buckles 122 are set at the proximal side part of the interior surfaces of the two opposite side walls of the shield cover 12. The buckles 122 may be elastically pressed against the two opposite side walls of the housing 11 below the guide bars 111 to fixate the housing 11 in place.

FIG. 5 shows an anti-entry device 3 for a single pair Ethernet female connector according to a first embodiment of the present disclosure. The anti-entry device 3 is configured to prevent accidental access or unauthorized access to the hollow interior of the female connector 1, and includes a protective cover 4 and an unlocking rod 5. The protective cover 4 is configured to removably close the proximal end opening of the female connector 1 to prevent access to the hollow interior of the female connector 1 from the outside. The unlocking rod 5 is configured to remove the protective cover 4 from the female connector 1 when the hollow interior of the female connector 1 needs to be accessed, so that the hollow interior of the female connector 1 is open to the outside.

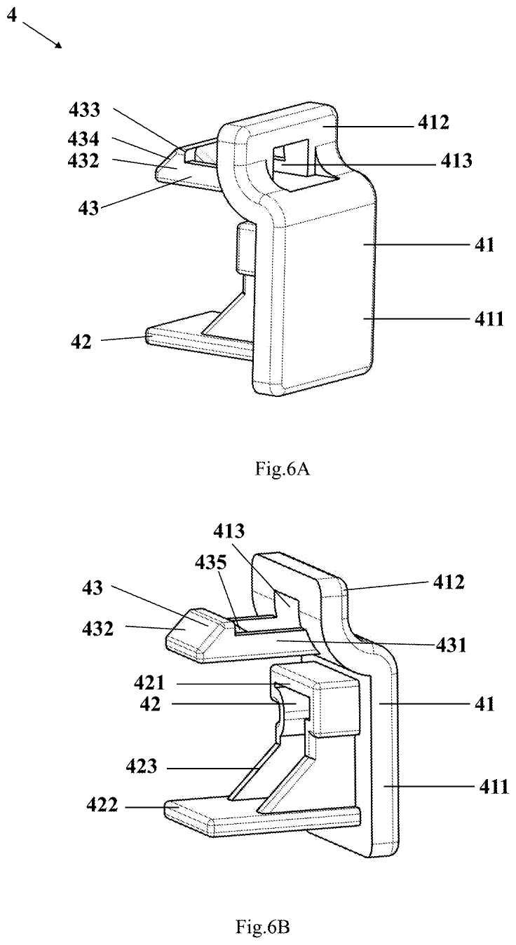

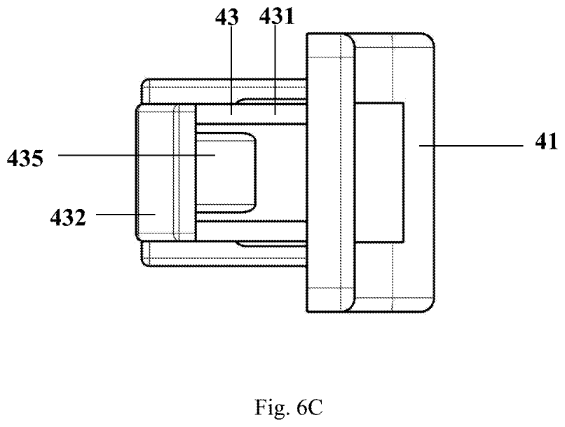

As shown in FIGS. 6A to 6C, the protective cover 4 includes a base plate 41, and a holding portion 42 and a locking portion 43 extending distally from the base plate 41. The base plate 41 is configured to close the proximal end opening of the female connector 1. The holding portion 42 is configured to hold the base plate 41 on the proximal end opening of the female connector 1. The locking portion 43 is configured to removably lock the base plate 41 to the proximal end opening of the female connector 1.

The base plate 41 covers the proximal end opening of the female connector 1 after the protective cover 4 is installed, and the outer contour shape thereof follows the outer contour shape of the housing 11 and/or the shield cover 12 of the female connector 1 at the proximal end opening. The base plate 41 includes a flat lower side part 411 and an upper side part 412 curved distally. The flat lower side part 411 abuts against the lower parts of the two opposite side walls and the bottom wall of the housing 11 and/or the shield cover 12 of the female connector 1, and the upper side part 412 curved distally abuts against the upper parts of the two opposite side walls and the top wall of the housing 11 and/or the shield cover 12 of the female connector 1. The base plate 41 is provided with a through-hole 413 for the unlocking rod 5 to pass through. The through-hole 413 may be all on the upper side part 412, or may be partly on the upper side part 412 and partly on the lower side part 411. In some embodiments, the through-hole 413 is on the upper side part 412, and its lower edge is at a position where the lower side part 411 and the upper side part 412 connect.

The holding portion 42 extends distally from the lower side part 411 of the base plate 41, and may be in a shape of a hollow frame or a shape of a solid block. The vertical cross-sectional shape of the holding portion 42 may match the lower side part in the proximal end opening of the female connector 1. The holding portion 42 includes a top wall 421, a bottom wall 422, and two side walls 423 connecting the top wall 421 and the bottom wall 422. The top wall 421 may be flat, and may be under the guide bar 111 of the female connector 1 and abut against the guide bar 111 after the protective cover 4 is installed. The bottom wall 422 may be flat and may abut against the bottom wall in the proximal end opening of the female connector 1. The two side walls 423 may follow the contours of the side walls in the proximal end opening of the female connector 1 in curved shapes to adapt to the shapes of the buckles 122 and other components of the female connector 1, and abut against the side walls of the female connector 1 after installation. In some embodiments, the length of the bottom wall 422 may be greater than the length of the top wall 421 so that the holding portion 42 is more securely placed in the female connector 1.

The locking portion 43 includes an elastic plate 431 and a hook-shaped portion 432. The hook-shaped portion 432 may be referred to as a latching portion. The elastic plate 431 extends distally from the lower edge of the through-hole 413 of the base plate 41 and has certain elasticity. The width of the elastic plate 431 may be equal to or greater than the width of the through-hole 413. The hook-shaped portion 432 is provided at the distal end of the elastic plate 431 and protrudes upward from the upper surface of the elastic plate 431 for locking to the guide block 112 of the female connector 1. In some embodiments, the hook-shaped portion 432 includes a vertical proximal surface 433 and an inclined distal surface 434. The vertical proximal surface 433 is configured to stably abut against the distal end surface of the guide block 112, and the inclined distal surface 434 is configured to guide the hook-shaped portion 432 smoothly over the guide block 112 from below.

In the process of installing the protective cover 4 to the proximal end opening of the female connector 1, the hook-shaped portion 432 is pressed downward by the guide block 112 of the female connector 1 and slides through the lower surface of the guide block 112, and at the same time the elastic plate 431 bends and deforms (i.e. deflects) downward. After the hook-shaped portion 432 goes over the guide block 112, the elastic plate 431 returns to its original shape, and the hook-shaped portion 432 is hooked to the distal end surface of the guide block 112. Now the guide block 112 is sandwiched between the upper side part 412 of the base plate 41 of the protective cover 4 and the hook-shaped portion 432 of the locking portion 43 on both the proximal and distal sides, and faces the elastic plate 431 of the locking portion 43 on the lower side surface. In some embodiments, the guide block 112 is sandwiched between the upper side part 412 and the hook-shaped portion 432 on both the proximal and distal sides, and there is basically no gap or a very small gap, and/or the guide block 112 faces the elastic plate 431 on the lower side surface, and there is basically no gap or a very small gap. When the protective cover 4 is pulled proximally away from the female connector 1, the proximal surface 433 of the hook-shaped portion 432 abuts against the distal end surface of the guide block 112, thereby preventing the protective cover 4 from being separated from the proximal end opening of the female connector 1.

The locking portion 43 further includes a guide slope 435 configured to guide the unlocking rod 5 over the hook-shaped portion 432. The guide slope 435 is provided on the proximal side of the hook-shaped portion 432 and abuts the central portion of the proximal surface 433 of the hook-shaped portion 432. The width of the guide slope 435 is smaller than the width of the gap 116 of the female connector 1, so that after the protective cover 4 is installed to the proximal end opening of the female connector 1, the guide slope 435 is in the gap 116.

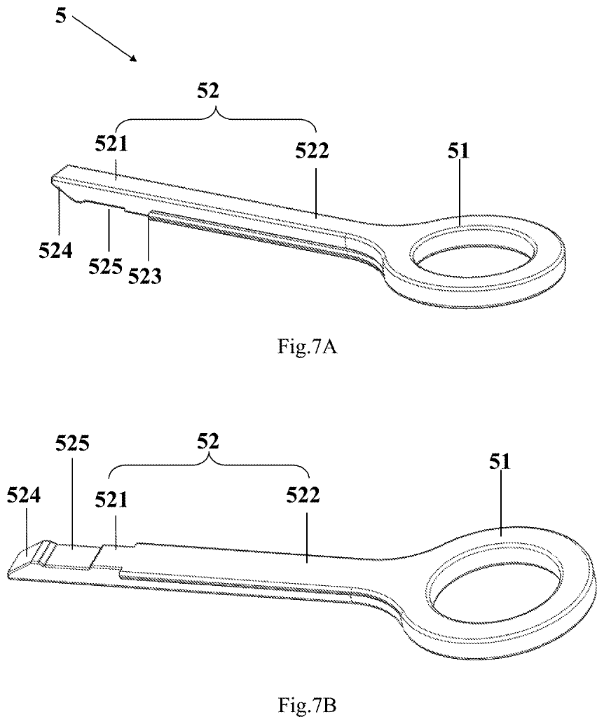

As shown in FIG. 7A and FIG. 7B, the unlocking rod 5 has a roughly elongated shape and includes a handle 51 and a rod 52 extending distally from the handle 51. The width of the handle 51 is far greater than that of the rod 52, making it convenient for a user to hold it and complete the inserting and pulling operations. In some embodiments, the handle 51 may have an annular shape, a circular shape, a polygonal shape, or any other shape that is easy to hold. In some embodiments, the handle 51 has rough texture, making it convenient for a user to firmly hold it without slipping.

The rod 52 is elongated and is configured to be inserted into the through-hole 413 of the protective cover 4 to approach and press the hook-shaped portion 432 of the locking portion 43 downward, so that the hook-shaped portion 432 is separated from the guide block 112 of the female connector 1. Along the longitudinal direction, the rod 52 includes an insertable section 521, which can be inserted into the protective cover 4, and an exposed section 522, which cannot be inserted into the protective cover 4. The outer contour dimension of the insertable section 521 is smaller than the dimension of the through-hole 413, while the outer contour dimension of the exposed section 522 is greater than the dimension of the through-hole 413. In some embodiments, the shape and dimension of the vertical cross section of the insertable section 521 match those of the through-hole 413. The longitudinal length of the insertable section 521 is slightly greater than the longitudinal length of the locking portion 43 of the protective cover 4 so as to ensure that the insertable section 521 can press the hook-shaped portion 432 of the protective cover 4. A stopper 523 is set on the rod 52 between the insertable section 521 and the exposed section 522. The stopper 523 is configured to prevent the rod 52 from being excessively inserted into the protective cover 4 to cause damage to the female connector 1.

The distal end of the insertable section 521 is provided with an inclined surface 524. The inclined surface 524 can slide through the guide slope 435 of the protective cover 4 to guide the insertable section 521 over the hook-shaped portion 432. The insertable section 521 is provided with a recess 525 at the proximal side of the inclined surface 524 to accommodate the hook-shaped portion 432 and the guide slope 435 on the curved elastic plate 431 of the protective cover 4 after the inclined surface 524 goes over the guide slope 435 of the protective cover 4.

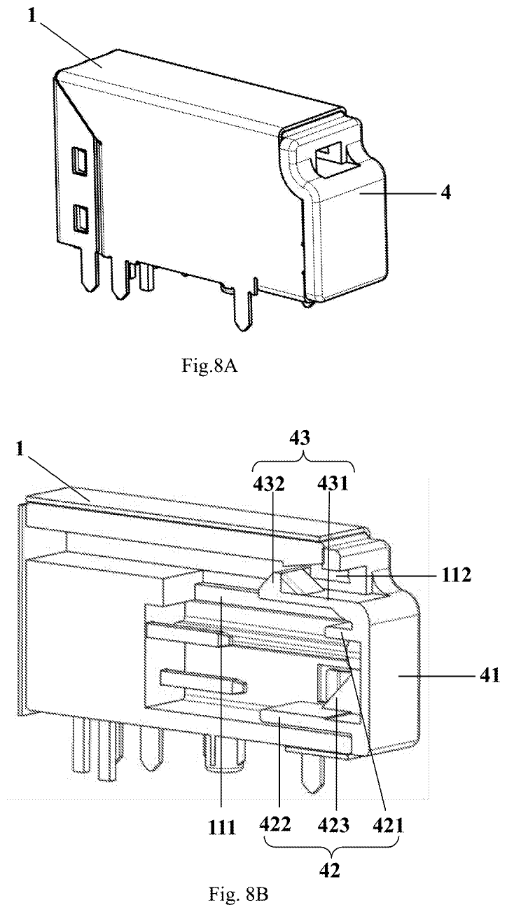

Now, a method of using the anti-entry device 3 according to the first embodiment of the present disclosure will be described by referencing FIGS. 8A to 11. First, as shown in FIGS. 8A and 8B, the base plate 41 of the protective cover 4 is held, the holding portion 42 and the locking portion 43 of the protective cover 4 are respectively aligned with the lower side part and the upper side part of the proximal end opening of the female connector 1 and inserted therein. The bottom wall 422, the top wall 421, and the two side walls 423 of the holding portion 42 slide distally along the bottom wall of the lower side part of the proximal end opening of the female connector 1, the lower surface of the guide bar 111, and the two side walls respectively into the proximal end opening of the female connector 1. The hook-shaped portion 432 of the locking portion 42 slides along the inclined distal surface 434 below the guide block 112 of the female connector 1 and passes through the lower surface of the guide block 112, and at the same time the elastic plate 431 bends and deforms downward. After the hook-shaped portion 432 goes over the guide block 112, the elastic plate 431 returns to its original shape, and the hook-shaped portion 432 is hooked to the distal end surface of the guide block 112. Now the protective cover 4 is locked in the front end opening of the female connector 1. When the protective cover 4 is pulled proximally away from the female connector 1, the proximal surface 433 of the hook-shaped portion 432 abuts against the distal end surface of the guide block 112, thereby preventing the protective cover 4 from being separated from the proximal end opening of the female connector 1.

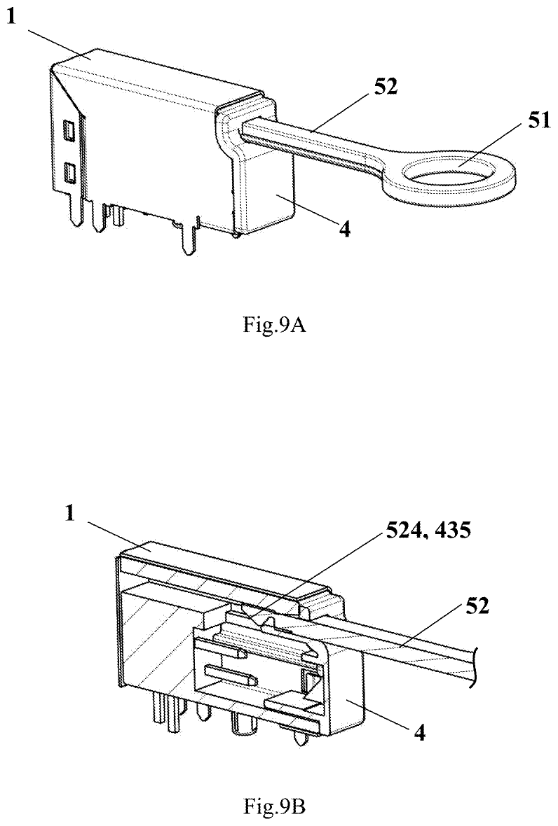

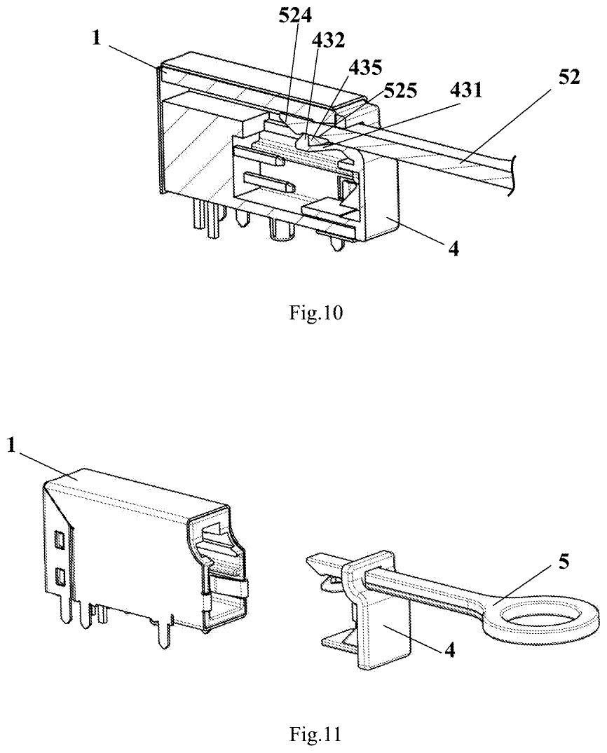

When the protective cover 4 needs to be removed from the proximal end opening of the female connector 1, as shown in FIGS. 9A and 9B, the handle 51 of the unlocking rod 5 is held and the rod 52 of the unlocking 51 is inserted into the through-hole 413 of the protective cover 4. The rod 52 is pushed distally until its inclined surface 524 abuts on the guide slope 435 of the protective cover 4. Continuing to push the rod 52 distally, the inclined surface 524 of the rod 52 presses the guide slope 435 of the protective cover 4 downward and causes the elastic plate 431 of the protective cover 4 to bend and deform downward. After the inclined surface 524 of the rod 52 passes through the guide slope 435 of the protective cover 4, the elastic plate 431 returns to a certain extent upward, and the hook-shaped portion 432 and the guide slope 435 of the protective cover 4 enter the recess 525 at the proximal side of the inclined surface 524 of the rod 52 and are held in place, as shown in FIG. 10.

The unlocking rod 5 is pulled proximally away from the female connector 1, and the recess 525 of the unlocking rod 5 drives the hook-shaped portion 432 and the guide slope 435 of the protective cover 4, and thereby drives the entire protective cover 4 to slide proximally and finally leave the proximal end opening of the female connector 1, thereby completing the removal of the protective cover 4 from the proximal end opening of the female connector 1, as shown in FIG. 11.

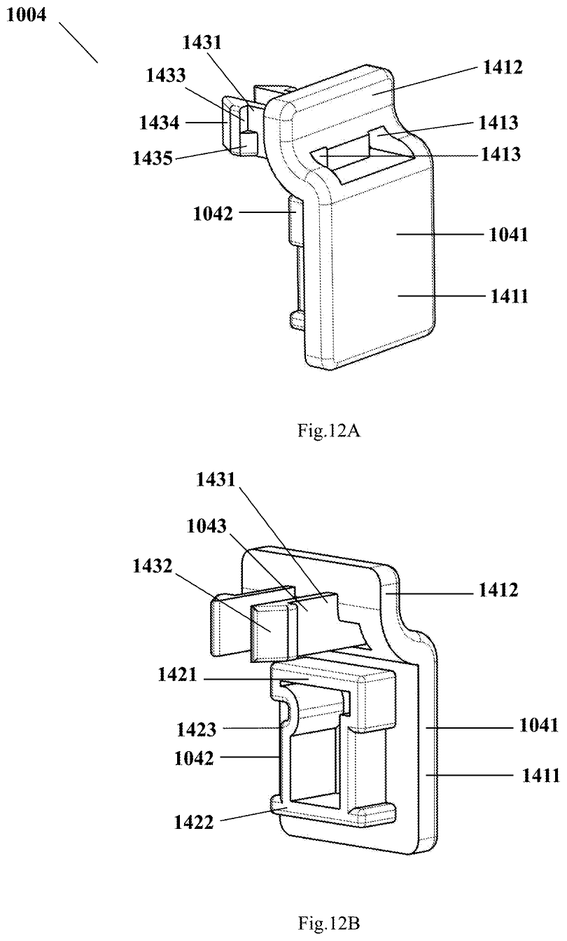

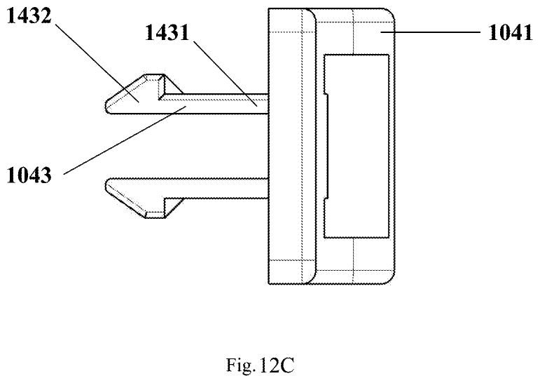

An anti-entry device 1003 for a single pair Ethernet female connector or coupler according to a second embodiment of the present disclosure will be described below with reference to FIGS. 12A to 14. For the anti-entry device 1003, 1000 will be added to the reference numerals in the anti-entry device 3 to indicate the same or similar structures.

The anti-entry device 1003 includes a protective cover 1004 and an unlocking rod 1005. The protective cover 1004 is configured to removably close the proximal end opening of the female connector 1 to prevent access to the hollow interior of the female connector 1 from the outside. The unlocking rod 1005 is configured to remove the protective cover 1004 from the female connector 1 when the hollow interior of the female connector 1 needs to be accessed, so that the hollow interior of the female connector 1 is open to the outside.

As shown in FIGS. 12A to 12C, the protective cover 1004 includes a base plate 1041, and a holding portion 1042 and a locking portion 1043 extending distally from the base plate 1041. The base plate 1041 is configured to close the proximal end opening of the female connector 1. The holding portion 1042 is configured to hold the base plate 1041 on the proximal end opening 115. The locking portion 1043 is configured to removably lock the base plate 1041 to the proximal end opening of the female connector 1.

The base plate 1041 covers the proximal end opening of the female connector 1 after the protective cover 1004 is installed, and the outer contour shape thereof follows the outer contour shape of the housing 11 and/or the shield cover 12 of the female connector 1 at the proximal end opening. The base plate 1041 includes a flat lower side part 1411 and an upper side part 1412 curved distally. The flat lower side part 1411 abuts against the lower parts of the two opposite side walls and the bottom wall of the housing 111 and/or the shield cover 12 of the female connector 1, and the upper side part 1412 curved distally abuts against the upper parts of the two opposite side walls and the top wall of the housing 111 and/or the shield cover 12 of the female connector 1. The base plate 1041 is provided with two side-by-side through-holes 1413 for the unlocking rod 1005 to pass through. Each through-hole 1413 may be all on the upper side part 1412, or may be partly on the upper side part 1412 and partly on the lower side part 1411. In some embodiments, each through-hole 1413 is provided on the upper side part 1412, and its lower edge is at a position where the lower side part 1411 and the upper side part 1412 connect.

The holding portion 1042 extends distally from the lower side part 1411 of the base plate 1041, and may be in a shape of a hollow frame or a shape of a solid block. The vertical cross-sectional shape of the holding portion 1042 may match the lower side part in the proximal end opening of the female connector 1. The holding portion 1042 includes a top wall 1421, a bottom wall 1422, and two side walls 1423 connecting the top wall 1421 and the bottom wall 1422. The top wall 1421 may be flat, and may be under the guide bar 111 of the female connector 1 and abut against the guide bar 111 after the protective cover 4 is installed. The bottom wall 1422 may be flat and may abut against the bottom wall in the proximal end opening of the female connector 1. The two side walls 1423 may follow the contours of the side walls in the proximal end opening of the female connector 1 in curved shapes to adapt to the shapes of the buckles 122 and other components of the female connector 1, and abut against the side walls of the female connector 1 after installation. In some embodiments, the length of the bottom wall 1422 may be greater than the length of the top wall 1421 so that the holding portion 1042 is more securely placed in the female connector 1.

The locking portion 1043 includes two elastic plates 1431 and two hook-shaped portions 1432. Each elastic plate 1431 extends distally from the inner edge of a corresponding through-hole 1413 of the base plate 1041 and has certain elasticity. The width of the elastic plate 431 may be equal to or greater than the width of the through-hole 413. Each hook-shaped portion 1432 is provided at the distal end of each elastic plate 1431 and protrudes upward from the upper surface of the elastic plate 1431 for locking to the guide block 112 of the female connector 1. In some embodiments, the hook-shaped portion 1432 includes a vertical proximal surface 1433 and an inclined distal surface 1434. The vertical proximal surface 1433 is configured to stably abut against the distal end surface of the guide block 112, and the inclined distal surface 1434 is configured to guide the hook-shaped portion 1432 smoothly over the guide block 112 from the inner side.

In the process of installing the protective cover 1004 to the proximal end opening of the female connector 1, each hook-shaped portion 1432 is pressed inward by the corresponding guide block 112 of the female connector 1 and slides through the inner surface of the guide block 112, and at the same time the elastic plate 1431 bends and deforms inward. After the hook-shaped portion 1432 goes over the guide block 112, the elastic plate 1431 returns to its original shape, and the hook-shaped portion 1432 is hooked to the distal end surface of the guide block 112. Now the guide block 112 is sandwiched between the upper side part 1412 of the base plate 1041 of the protective cover 1004 and the hook-shaped portion 1432 of the locking portion 1043 on both the proximal and distal sides, and faces the elastic plate 1431 of the locking portion 1043 on the inner side surface. In some embodiments, the guide block 112 is sandwiched between the upper side part 1412 and the hook-shaped portion 1432 on both the proximal and distal sides, and there is basically no gap or a very small gap, and/or the guide block 112 faces the elastic plate 1431 on the inner side surface, and there is basically no gap or a very small gap. When the protective cover 1004 is pulled proximally away from the female connector 1, the proximal surface 1433 of the hook-shaped portion 1432 abuts against the distal end surface of the guide block 112, thereby preventing the protective cover 1004 from being separated from the proximal end opening of the female connector 1.

The locking portion 1043 further includes a guide slope 1435 configured to guide the unlocking rod 1005 over the hook-shaped portion 1432. The guide slope 1435 is provided on the proximal side of the hook-shaped portion 432 and abuts the lower side of the proximal surface 1433 of the hook-shaped portion 1432.

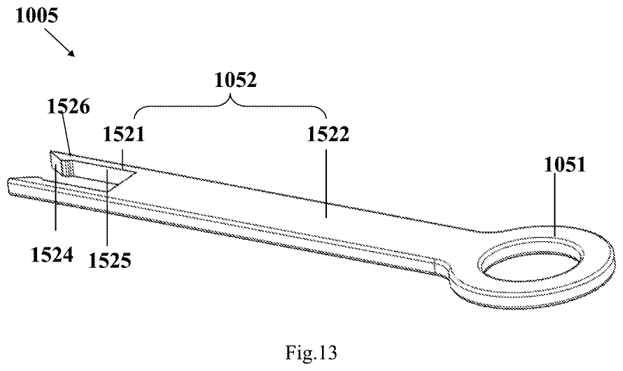

As shown in FIG. 13, the unlocking rod 1005 has a roughly elongated shape and includes a handle 1051 and a rod 1052 extending distally from the handle 1051. The width of the handle 1051 is far greater than that of the rod 1052, making it convenient for a user to hold it and complete the inserting and pulling operations. In some embodiments, the handle 1051 may have an annular shape, a circular shape, a polygonal shape, or any other shape that is easy to hold. In some embodiments, the handle 1051 has a rough texture, making it convenient for a user to firmly hold it without slipping.

The rod 1052 is elongated and is configured to be inserted into the two through-holes 1413 of the protective cover 1004 to approach and press the two hook-shaped portions 1432 of the locking portion 1043 inward, so that the two hook-shaped portions 1432 are separated from the two guide blocks 112 of the female connector 1. Along the longitudinal direction, the rod 1052 includes an insertable section 1521, which can be inserted into the protective cover 1004, and an exposed section 1522, which cannot be inserted into the protective cover 1004. The insertable section 1521 includes two protruding portions 1526 protruding distally from the left and right sides of the exposed section 1522. The two protruding portions 1526 are respectively inserted into the two through-holes 1413 of the protective cover 1004.

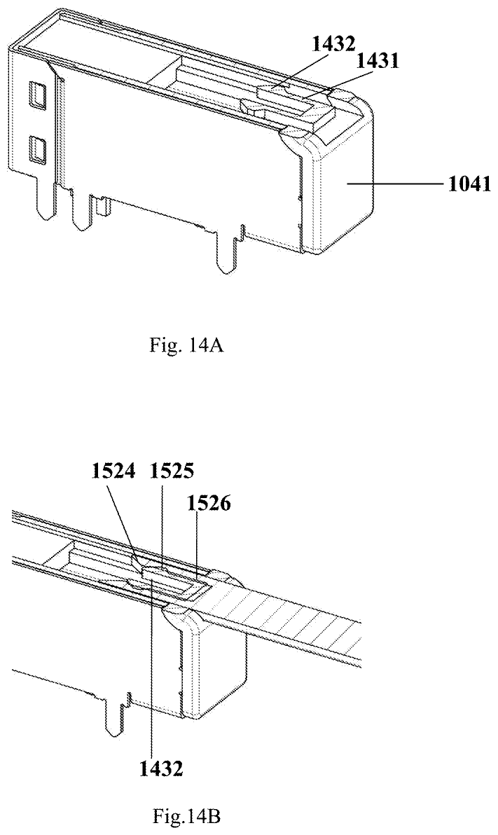

The distal end of each protruding portion 1526 is provided with an inclined surface 1524. The inclined surface 1524 can slide through the guide slope 1435 of the protective cover 1004 to guide the unlocking rod 1005 over the hook-shaped portion 1432. The protruding portion 1526 is provided with a recess 1525 at the proximal side of the inclined surface 1524 to accommodate the hook-shaped portion 1432 and the guide slope 1435 on the curved elastic plate 1431 of the protective cover 1004 after the inclined surface 1524 goes over the guide slope 1435 of the protective cover 1004, as shown in FIGS. 14A-14B.

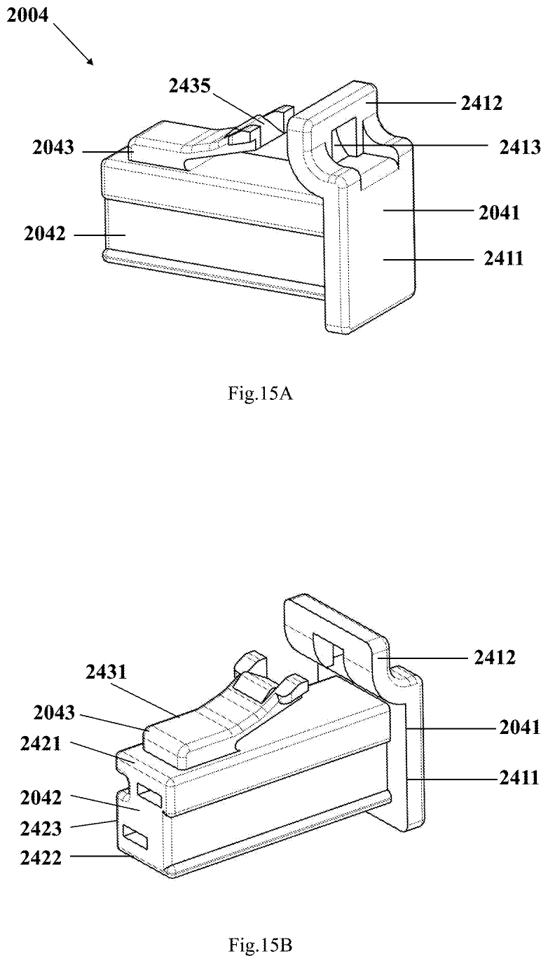

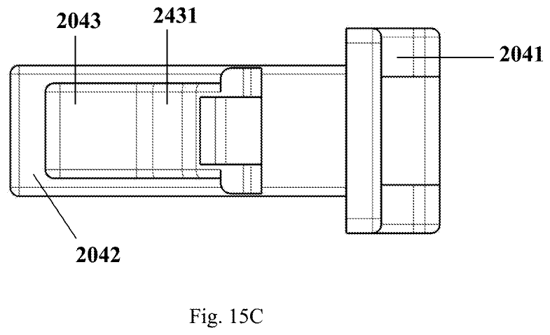

An anti-entry device 2003 for a single pair Ethernet female connector or coupler according to a third embodiment of the present disclosure will be described below with reference to FIGS. 15A to 17. For the anti-entry device 2003, 2000 will be added to the reference numerals in the anti-entry device 3 to indicate the same or similar structures.

The anti-entry device 2003 includes a protective cover 2004 and an unlocking rod 2005. The protective cover 2004 is configured to removably close the proximal end opening of the female connector 1 to prevent access to the hollow interior of the female connector 1 from the outside. The unlocking rod 2005 is configured to remove the protective cover 2004 from the female connector 1 when the hollow interior of the female connector 1 needs to be accessed, so that the hollow interior of the female connector 1 is open to the outside.

As shown in FIGS. 15A to 15C, the protective cover 2004 includes a base plate 2041, a holding portion 2042 extending distally from the base plate 2041, and a locking portion 2043 provided on the holding portion 2042. The base plate 2041 is configured to close the proximal end opening of the female connector 1. The holding portion 2042 is configured to hold the base plate 2041 on the proximal end opening 115. The locking portion 2043 is configured to removably lock the base plate 2041 to the proximal end opening of the female connector 1.

The base plate 2041 covers the proximal end opening of the female connector 1 after the protective cover 2004 is installed, and the outer contour shape thereof follows the outer contour shape of the housing 11 and the shield cover 12 of the female connector 1 at the proximal end opening. The base plate 2041 includes a flat lower side part 2411 and an upper side part 2412 curved distally. The flat lower side part 2411 abuts against the lower parts of the two opposite side walls and the bottom wall of the housing 11 and/or the shield cover 12 of the female connector 1, and the upper side part 2412 curved distally abuts against the upper parts of the two opposite side walls and the top wall of the housing 11 and/or the shield cover 12 of the female connector 1. The base plate 2041 is provided with a through-hole 2413 for the unlocking rod 2005 to pass through. The through-hole 2413 may be all on the upper side part 2412, or may be partly on the upper side part 2412 and partly on the lower side part 2411. In some embodiments, the through-hole 2413 is on the upper side part 2412, and its lower edge is at a position where the lower side part 2411 and the upper side part 2412 connect.

The holding portion 2042 extends distally from the lower side part 2411 of the base plate 2041, and may be in a shape of a hollow frame or a shape of a solid block. The vertical cross-sectional shape of the holding portion 2042 may match the lower side part in the proximal end opening of the female connector 1. The holding portion 2042 includes a top wall 2421, a bottom wall 2422, and two side walls 2423 connecting the top wall 2421 and the bottom wall 2422. The top wall 2421 may be flat, and may be under the guide bar 111 of the female connector 1 and abut against the guide bar 111 after the protective cover 4 is installed. The bottom wall 2422 may be flat, and may be installed above the bottom wall in the proximal end opening of the female connector 1 and abut against the bottom wall. The two side walls 2423 may follow the contours of the side walls in the proximal end opening of the female connector 1 in curved shapes to adapt to the shapes of the buckles 122 and other components of the female connector 1, and abut against the side walls of the female connector 1 after installation.

The locking portion 2043 includes an elastic plate 2431. The distal end of the elastic plate 2431 is fixed to the distal side part of the top wall 2421 of the holding portion 2042 and protrudes obliquely to the proximal side. The proximal end of the elastic plate 2431 may be widened for abutting against and locking to the guide block 112 of the female connector 1.

In the process of installing the protective cover 2004 to the proximal end opening of the female connector 1, the proximal end of the elastic plate 2431 is pressed downward by the guide block 112 of the female connector 1 and slides through the lower surface of the guide block 112, and at the same time the main body of the elastic plate 2431 bends and deforms downward. After the proximal end of the elastic plate 2431 goes over the guide block 112, the elastic plate 2431 returns to its original shape, and its proximal end abuts on the distal end surface of the guide block 112. Now the guide block 112 is sandwiched between the upper side part 2412 of the base plate 2041 of the protective cover 2004 and the elastic plate 2431 of the locking portion 2043 on both the proximal and distal sides, and faces the top wall 2421 of the holding portion 2042 on the lower side surface. In some embodiments, the guide block 112 is sandwiched between the upper side part 2412 and the proximal end of the elastic plate 2431 on both the proximal and distal sides, and there is basically no gap or a very small gap, and/or the guide block 112 faces the top wall 2421 of the holding portion 2042 on the lower side surface, and there is basically no gap or a very small gap. When the protective cover 2004 is pulled proximally away from the female connector 1, the proximal end of the elastic plate 2431 abuts against the distal end surface of the guide block 112, thereby preventing the protective cover 2004 from being separated from the proximal end opening of the female connector 1.

The locking portion 2043 further includes a guide slope 2435 configured to guide the unlocking rod 2005 over the proximal end of the elastic plate 2431. The guide slope 2435 is provided in the central portion of the proximal end of the elastic plate 2431. When the protective cover 2004 is installed to the proximal end of the female connector 1, the guide slope 2435 is at the distal side of the two guide blocks 112 of the female connector 113.

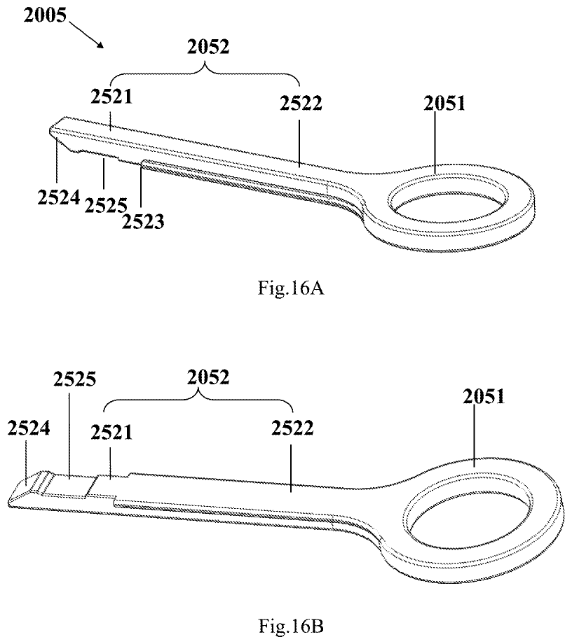

As shown in FIG. 16A and FIG. 16B, the unlocking rod 2005 has a roughly elongated shape and includes a handle 2051 and a rod 2052 extending distally from the handle 2051. The width of the handle 2051 is far greater than that of the rod 2052, making it convenient for a user to hold it and complete the inserting and pulling operations. In some embodiments, the handle 2051 may have an annular shape, a circular shape, a polygonal shape, or any other shape that is easy to hold. In some embodiments, the handle 2051 has rough texture, making it convenient for a user to firmly hold it without slipping.

The rod 2052 is elongated and is configured to be inserted into the through-hole 2413 of the protective cover 2004 to approach and press the proximal end of the elastic plate 2431 of the locking portion 2043 downward, so that the proximal end is separated from the guide block 112 of the female connector 1. Along the longitudinal direction, the rod 2052 includes an insertable section 2521, which can be inserted into the protective cover 2004, and an exposed section 2522, which cannot be inserted into the protective cover 2004. The outer contour dimension of the insertable section 2521 is smaller than the dimension of the through-hole 2413, while the outer contour dimension of the exposed section 2522 is greater than the dimension of the through-hole 2413. In some embodiments, the shape and dimension of the vertical cross section of the insertable section 2521 match those of the through-hole 2413. A stopper 2523 is set on the rod 2052 between the insertable section 2521 and the exposed section 2522. The stopper 2523 is configured to prevent the rod 2052 from being excessively inserted into the protective cover 2004 to cause damage to the female connector 1.

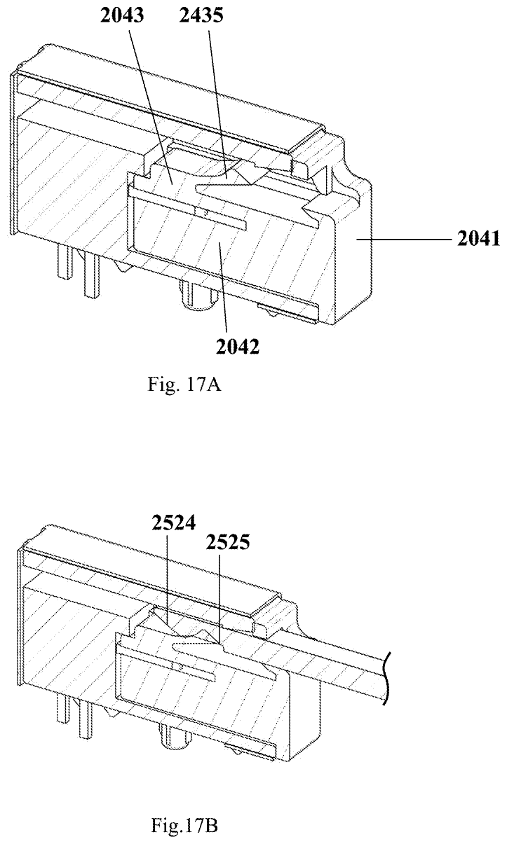

The distal end of the insertable section 2521 is provided with an inclined surface 2524. The inclined surface 2524 can slide through the guide slope 2435 of the protective cover 2004 to guide the insertable section 2521 over the proximal end of the elastic plate 2431. The insertable section 2521 is provided with a recess 2525 at the proximal side of the inclined surface 2524 to accommodate the proximal end of the curved elastic plate 2431 of the protective cover 2004 after the inclined surface 2524 goes over the guide slope 2435 of the protective cover 2004, as shown in FIGS. 17A-17B.

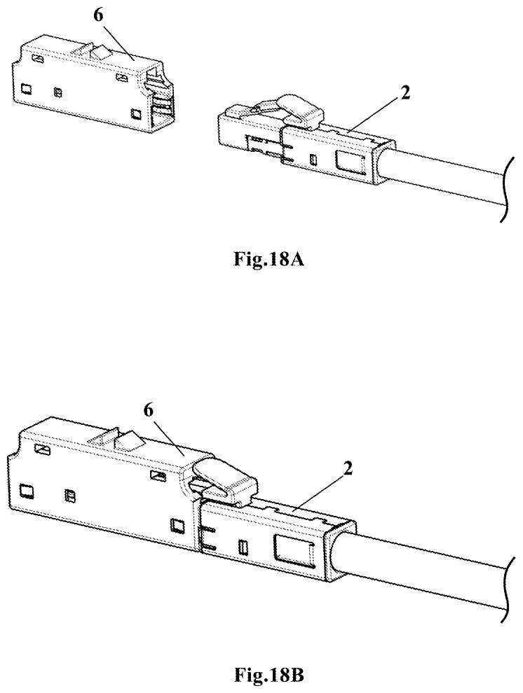

The anti-entry devices 3, 1003, and 2003 according to the embodiments of the present disclosure can be used not only for a female connector of a single pair Ethernet connector assembly, but also for a coupler 6. FIG. 18A and FIG. 18B show a single pair Ethernet connector assembly including the coupler 6 and the male connectors 2. There are openings at both ends of the coupler 6 to receive two male connectors 2 and to electrically connect the two male connectors 2. The connection and locking method between each end of the coupler 6 and a male connector 2 is similar to those of the female connector 1, and thus it is not repeated.

An anti-entry device according to an embodiment of the present disclosure can be easily installed to a female connector or coupler of a single pair Ethernet connector assembly without changes to the original structure of the single pair Ethernet connector assembly.

An anti-entry device according to an embodiment of the present disclosure can effectively prevent accidental access or unauthorized access to the interior of a female connector or coupler of a single pair Ethernet connector assembly.

An anti-entry device according to an embodiment of the present disclosure has a simple structure and low cost, and can be widely used in various corporate and consumer markets.

### Additional Aspects

Aspect 1: An anti-entry device for a single pair Ethernet female connector or coupler, wherein the anti-entry device is configured to prevent accidental entry or unauthorized entry from outside into a hollow interior of the female connector or coupler, and includes: a protective cover, which includes a base plate, a holding portion, and a locking portion, the base plate being configured to cover a proximal end opening of the female connector or coupler after the protective cover is installed, and including a through hole, the holding portion being configured to extend distally from the base plate and to hold the base plate on the proximal end opening of the female connector or coupler, the locking portion being configured to extend from the base plate or the holding portion and removably lock the base plate to a guide block at the proximal end opening of the female connector; an unlocking rod, which is elongated and capable of passing through the through hole of the protective cover to press the locking portion downward so as to unlock the protective cover from the female connector or coupler; wherein the holding portion includes a top wall, a bottom wall, and two side walls connecting the top wall and the bottom wall, wherein the top wall is flat and is under and abuts against a guide bar of the female connector, the bottom wall is flat and is above and abuts against the bottom wall in the proximal end opening of the female connector, and the two side walls are curved following the contours of the side walls in the proximal end opening of the female connector.

Aspect 2: The anti-entry device according to Aspect 1, wherein an outer contour shape of the base plate is designed to follow an outer contour shape of the female connector or coupler at the proximal end opening, and the base plate includes a flat lower side part and an upper side part curved distally.

Aspect 3: The anti-entry device according to Aspect 2, wherein the lower side part is configured to abut against lower parts of two opposite side walls and a bottom wall of the female connector, and the upper side part is configured to abut against upper parts of the two opposite side walls and a top wall of the female connector.

Aspect 4: The anti-entry device according to Aspect 2, wherein the through hole is set to be all on the upper side part, or set to be partly on the upper side part and partly on the lower side part.

Aspect 5: The anti-entry device according to Aspect 2, wherein the through hole is set to be on the upper side part, and a lower edge of the through hole is at a position where the lower side part and the upper side part connect.

Aspect 6: Then anti-entry device according to Aspect 1, wherein the holding portion is in a shape of a hollow frame or a shape of a solid block.

Aspect 7: The anti-entry device according to Aspect 2, wherein the holding portion is configured to extend distally from the lower side part of the base plate, and its vertical cross-sectional shape matches the lower side part in the proximal end opening of the female connector.

Aspect 8: The anti-entry device according to any one of Aspects 1 to 7, wherein the locking portion includes an elastic plate and a hook-shaped portion, wherein the elastic plate extends distally from the lower edge of the through hole of the protective cover, and the hook-shaped portion is provided at a distal end of the elastic plate and protrudes upward from an upper surface of the elastic plate.

Aspect 9: The anti-entry device according to Aspect 8, wherein the elastic plate has a width designed to be equal to or greater than that of the through hole.

Aspect 10: The anti-entry device according to Aspect 8, wherein the hook-shaped portion includes a vertical proximal surface and an inclined distal surface, wherein the vertical proximal surface is configured to abut against a distal end surface of the guide block, and the inclined distal surface is configured to guide the hook-shaped portion over the guide block.

Aspect 11: The anti-entry device according to Aspect 8, wherein after the protective cover is installed, the guide block of the female connector is sandwiched between the base plate of the protective cover and the hook-shaped portion of the locking portion on both proximal and distal sides, and faces the elastic plate of the locking portion on the lower side surface.

Aspect 12: The anti-entry device according to Aspect 8, wherein the locking portion includes a guide slope configured to guide the unlocking rod over the hook-shaped portion, wherein the guide slope is provided to abut the proximal side of the hook-shaped portion.

Aspect 13: The anti-entry device according to Aspect 12, wherein the guide slope has a width smaller than that of a gap between the two guide blocks of the female connector, so that after the protective cover is installed, the guide slope is in the gap.

Aspect 14: The anti-entry device according to Aspect 12, wherein the unlocking rod includes a handle and a rod extending distally from the handle, and the handle has a width far greater than that of the rod.

Aspect 15: The anti-entry device according to Aspect 14, wherein the handle has rough texture to make it easy for a user to hold it without slipping.

Aspect 16: The anti-entry device according to Aspect 14, wherein along the longitudinal direction, the rod includes an insertable section, which can be inserted into the protective cover, and an exposed section, which cannot be inserted into the protective cover, wherein the outer contour dimension of the insertable section is configured to be smaller than the dimension of the through hole, and the outer contour dimension of the exposed section is configured to be greater than the dimension of the through hole.

Aspect 17: The anti-entry device according to Aspect 16, wherein a stopper is provided on the rod between the insertable section and the exposed section, and the stopper is configured to prevent the rod from being excessively inserted into the protective cover.

Aspect 18: The anti-entry device according to Aspect 16, wherein the distal end of the insertable section is provided with an inclined surface that can slide through the guide slope of the protective cover to guide the insertable section over the hook-shaped portion, and the insertable section is provided with a recess at the proximal side of the inclined surface, the recess being configured to accommodate the hook-shaped portion and the guide slope on the curved elastic plate of the protective cover after the inclined surface goes over the guide slope of the protective cover.

Aspect 19: The anti-entry device according to any one of Aspects 1 to 7, wherein the through hole of the protective cover includes two side-by-side through holes, the locking portion includes two elastic plates and two hook-shaped portions, each elastic plate extends distally from an inner edge of a corresponding through hole of the base plate, and each hook-shaped portion is provided at the distal end of each elastic plate and protrudes outward from an outer surface of the elastic plate.

Aspect 20: The anti-entry device according to Aspect 19, wherein the elastic plates have a height designed to be equal to or greater than that of the through holes.

Aspect 21: The anti-entry device according to Aspect 19, wherein each hook-shaped portion includes a vertical proximal surface and an inclined distal surface, wherein the vertical proximal surface is configured to stably abut against the distal end surface of the guide block, and the inclined distal surface is configured to guide the hook-shaped portion smoothly over the guide block from an inner side.

Aspect 22: The anti-entry device according to Aspect 19, wherein, after the protective cover is installed, the guide block of the female connector is sandwiched between the base plate of the protective cover and each hook-shaped portion of the locking portion on both proximal and distal sides, and faces the elastic plates of the locking portion on the inner surface.

Aspect 23: The anti-entry device according to Aspect 19, wherein the locking portion further includes a guide slope configured to guide the unlocking rod over the hook-shaped portions, and the guide slope is provided to abut the proximal side of the hook-shaped portions.

Aspect 24: The anti-entry device according to Aspect 19, wherein the unlocking rod includes a handle and a rod extending distally from the handle, and the handle has a width far greater than that of the rod.

Aspect 25: The anti-entry device according to Aspect 24, wherein the handle has rough texture to make it easy for a user to hold it without slipping.

Aspect 26: The anti-entry device according to Aspect 24, wherein along the longitudinal direction, the rod includes an insertable section, which can be inserted into the protective cover, and an exposed section, which cannot be inserted into the protective cover, wherein the insertable section includes two protruding portions protruding distally from the exposed section, and the two protruding portions can be respectively inserted into the two through holes of the protective cover.

Aspect 27: The anti-entry device according to Aspect 26, wherein the distal end of the insertable section is provided with an inclined surface that can slide through the guide slope of the protective cover to guide the insertable section over the hook-shaped portions, and the insertable section is provided with a recess at the proximal side of the inclined surface, the recess being configured to accommodate the hook-shaped portions and the guide slope on the curved elastic plates of the protective cover after the inclined surface goes over the guide slope of the protective cover.

Aspect 28: The anti-entry device according to any one of Aspects 1 to 7, wherein the locking portion includes an elastic plate, and a distal end of the elastic plate is fixed to the top wall of the holding portion and protrudes obliquely to the proximal side.

Aspect 29: The anti-entry device according to Aspect 28, wherein a proximal end of the elastic plate is designed to be widened.

Aspect 30: The anti-entry device according to Aspect 28, wherein, after the protective cover is installed, the guide block of the female connector is sandwiched between the base plate of the protective cover and the proximal end of the elastic plate of the locking portion on both proximal and distal sides, and faces the top wall of the holding portion on the lower side surface.

Aspect 31: The anti-entry device according to Aspect 28, wherein the locking portion further includes a guide slope configured to guide the unlocking rod over the hook-shaped portion, the guide slope being provided on the proximal end of the elastic plate.

Aspect 32: The anti-entry device according to Aspect 28, wherein the unlocking rod includes a handle and a rod extending distally from the handle, and the handle has a width far greater than that of the rod.

Aspect 33: The anti-entry device according to Aspect 32, wherein the handle has rough texture to make it easy for a user to hold it without slipping.

Aspect 34: The anti-entry device according to Aspect 32, wherein along the longitudinal direction, the rod includes an insertable section, which can be inserted into a protective cover, and an exposed section, which cannot be inserted into the protective cover, wherein the outer contour dimension of the insertable section is configured to be smaller than the dimension of the through hole, and the outer contour dimension of the exposed section is configured to be greater than the dimension of the through hole.

Aspect 35: The anti-entry device according to Aspect 32, wherein a stopper is provided on the rod between the insertable section and the exposed section, and the stopper is configured to prevent the rod from being excessively inserted into the protective cover.

Aspect 36: The anti-entry device according to Aspect 32, wherein the distal end of the insertable section is provided with an inclined surface that can slide through the guide slope of the protective cover to guide the insertable section over the hook-shaped portion, and the insertable section is provided with a recess at the proximal side of the inclined surface, the recess being configured to accommodate the hook-shaped portion and the guide slope on the curved elastic plate of the protective cover after the inclined surface goes over the guide slope of the protective cover.

Although the exemplary embodiments of the present disclosure have been described, it should be understood by those of ordinary skill in the art that a plurality of variations and changes can be created and made to the exemplary embodiments of the present disclosure without essentially departing from the spirit and scope of the present disclosure. Therefore, all variations and changes are included in the protection scope of the present disclosure defined by the claims. The present disclosure is defined by the attached claims, and equivalents of these claims are also included.

What is claimed is:

1. An anti-entry device for a single pair Ethernet female connector or coupler, wherein the anti-entry device is configured to prevent accidental entry or unauthorized entry from outside into a hollow interior of the female connector or coupler, the anti-entry device comprising:
a protective cover, which includes a base plate, a holding portion, and a locking portion, the base plate being configured to cover a proximal end opening of the female connector or coupler after the protective cover is installed, and including a through-hole, the holding portion being configured to extend distally from the base plate and to hold the base plate on the proximal end opening of the female connector or coupler, the locking portion being configured to extend from the base plate or the holding portion and removably lock the base plate to a guide block at the proximal end opening of the female connector;
an unlocking rod, which is elongated and capable of passing through the through-hole of the protective cover to press the locking portion downward so as to unlock the protective cover from the female connector or coupler;
wherein the holding portion includes a top wall, a bottom wall, and two side walls connecting the top wall and the bottom wall, wherein the top wall is flat and is under and abuts against a guide bar of the female connector, the bottom wall is flat and is above and abuts against the bottom wall in the proximal end opening of the female connector, and the two side walls are curved following the contours of the side walls in the proximal end opening of the female connector.

2. The anti-entry device of claim 1, wherein an outer contour shape of the base plate is designed to follow an outer contour shape of the female connector or coupler at the proximal end opening, and the base plate includes a flat lower side part and an upper side part curved distally.

3. The anti-entry device of claim 2, wherein the lower side part is configured to abut against lower parts of two opposite side walls and a bottom wall of the female connector, and the upper side part is configured to abut against upper parts of the two opposite side walls and a top wall of the female connector.

4. The anti-entry device of claim 2, wherein the through-hole is set to be all on the upper side part, or set to be partly on the upper side part and partly on the lower side part.

5. The anti-entry device of claim 2, wherein the through-hole is set to be on the upper side part, and a lower edge of the through-hole is at a position where the lower side part and the upper side part connect.

6. Then anti-entry device of claim 1, wherein the holding portion is in a shape of a hollow frame or a shape of a solid block.

7. The anti-entry device of claim 2, wherein the holding portion is configured to extend distally from the lower side part of the base plate, and its vertical cross-sectional shape matches the lower side part in the proximal end opening of the female connector.

8. The anti-entry device of claim 1, wherein the locking portion includes an elastic plate and a hook-shaped portion, wherein the elastic plate extends distally from the lower edge of the through-hole of the protective cover, and the hook-shaped portion is provided at a distal end of the elastic plate and protrudes upward from an upper surface of the elastic plate.

9. The anti-entry device of claim 8, wherein the elastic plate has a width designed to be equal to or greater than that of the through-hole.

10. The anti-entry device of claim 8, wherein the hook-shaped portion includes a vertical proximal surface and an inclined distal surface, wherein the vertical proximal surface is configured to abut against a distal end surface of the guide block, and the inclined distal surface is configured to guide the hook-shaped portion over the guide block.

11. The anti-entry device of claim 8, wherein after the protective cover is installed, the guide block of the female connector is sandwiched between the base plate of the protective cover and the hook-shaped portion of the locking portion on both proximal and distal sides, and faces the elastic plate of the locking portion on the lower side surface.

12. The anti-entry device of claim 8, wherein the locking portion includes a guide slope configured to guide the unlocking rod over the hook-shaped portion, wherein the guide slope abuts the proximal side of the hook-shaped portion.

13. The anti-entry device of claim 12, wherein the guide slope has a width smaller than that of a gap between a pair of guide blocks of the female connector, so that after the protective cover is installed, the guide slope is in the gap.

14. The anti-entry device of claim 12, wherein the unlocking rod includes a handle and a rod extending distally from the handle, and the handle has a width far greater than that of the rod.

15. The anti-entry device of claim 14, wherein along the longitudinal direction, the rod includes an insertable section, which can be inserted into the protective cover, and an exposed section, which cannot be inserted into the protective cover, wherein the outer contour dimension of the insertable section is configured to be smaller than the dimension of the through-hole, and the outer contour dimension of the exposed section is configured to be greater than the dimension of the through-hole.

16. The anti-entry device of claim 15, wherein a stopper is provided on the rod between the insertable section and the exposed section, and the stopper is configured to prevent the rod from being excessively inserted into the protective cover.

17. The anti-entry device of claim 16, wherein a distal end of the insertable section is provided with an inclined surface that can slide through the guide slope of the protective cover to guide the insertable section over the hook-shaped portion, and the insertable section is provided with a recess at the proximal side of the inclined surface, the recess being configured to accommodate the hook-shaped portion and the guide slope on the curved elastic plate of the protective cover after the inclined surface goes over the guide slope of the protective cover.

18. An anti-entry device for a connector, the anti-entry device comprising:
a protective cover, which includes a base plate and a deflectable locking portion, the base plate being configured to cover a proximal end opening of the connector and including a through-hole, the deflectable locking portion including a latching portion for engaging with an interior surface within the connector to lock the base plate to the connector; and
an unlocking rod including a member insertable through the through-hole to deflect the locking portion to disengage the latching portion from the connector interior surface so as to unlock the protective cover from the connector, and such that the member engages with the latching portion such that the protective cover can be removed from the proximal end opening with the unlocking rod.

19. The anti-entry device of claim 18, wherein the member is a single member.

20. The anti-entry device of claim 18, wherein the locking portion includes a guide slope configured to guide the member over the latching portion, wherein the guide slope abuts a proximal side of the latching portion.
